(19) United States
(12) Patent Application Publication
(10) Pub. No.: US 2006/0182667 A1
(43) Pub. Date: Aug. 17, 2006

(54) Device and process for the simultaneous agitation of reaction mixtures

(76) Inventors: Torsten Zech, Heidelberg (DE); Stephan Andreas Schunk, Heidelberg (DE); Alfred Haas, Eppelheim (DE)

Correspondence Address: Stephen D Scanion;Jones Day, North Point, 901 Lakeside Avenue, Cleveland, OH, 44114, US

(21) Appl. No.: 10/543,074

(22) PCT Filed: Feb. 6, 2004
(86) PCT No.: PCT/EP04/01124

§ 371 Date: Sep. 30, 2005

(30) Foreign Application Priority Data
Feb. 6, 2003 (DE) 10304855.3

(51) Int. Cl. B01J 19/00

(52) U.S. Cl. 422/130

(57) ABSTRACT

The present invention is in the field of the high-throughput research for liquid and multi-phase reactions. Thereby, the invention relates to a process for the simultaneous realization of at least one chemical reaction in at least two separate reaction vessels (10), wherein said process comprises at least the following steps: (i) providing at least one reaction mixture per reaction vessel (10); to (ii) pneumatic agitation of the reaction mixture in at least one reaction vessel by means of bringing the reaction mixture into contact with at least one fluid phase (18), wherein the at least one chemical reaction is carried out in at least one of the reaction vessels (10) in the batch mode and the reaction mixture contains at least one liquid phase (14). Thereby, the fluid phase (18) is supplied to the at least one reaction vessel (10) within a defined period and is at least partially discharged from the reaction vessel. The reaction mixturee may further comprise another immiscible liquid phase (14′) and/or solid phase (16). Furthermore, the present invention relates to the device, which pertains to the process.

The present invention is in the field of the high-throughput research for liquid and multi-phase reactions. Thereby, the invention relates to a process for the simultaneous realization of at least one chemical reaction in at least two separate reaction vessels, wherein said process comprises at least the following steps:
(i) providing at least one reaction mixture per reaction vessel;
(ii) pneumatic agitation of the reaction mixture in at least one reaction vessel by means of bringing the reaction mixture into contact with at least one fluid phase,
   wherein the at least one chemical reaction is carried out in at least one of the reaction vessels in the batch mode and wherein the reaction mixture contains at least one liquid phase. Thereby, the fluid phase is supplied to the at least one reaction vessel within a defined period, and is at least partially discharged from the reaction vessel.

Furthermore, the present invention relates to a device for the simultaneous realization of at least one chemical reaction in at least two separate reaction vessels, wherein said device comprises at least the following components:
(i) at least two separate reaction vessels with at least one reaction mixture per reaction vessel;
(ii) at least one means for supply of at least one fluid phase in at least one reaction vessel,
   wherein the means for supply must be formed in a manner that it permits the pneumatic agitation of the reaction mixture in at least one reaction vessel by means of the fluid phase. Thereby, the supply of the fluid phase preferably takes place by means of a plurality of means for supply, which are materially linked together. In the device according to the invention the chemical reaction is also carried out in at least one reaction vessel in the batch mode.

Furthermore, the present invention relates to the use of said process and/or the device for the realization of reactions, in which at least one liquid phase takes part. Among said reactions are in particular, but not exclusively: oxidations, hydrogenations, hydrohalogenations, halogenations, hydroformulations, ozonolysis, carboxylations, alkylations, fermentation reactions, polymerization reactions, manufacture of inorganic solid bodies, waste water treatment or, for example, the Fischer-Tropsch-synthesis. Such reactions are preferred, in which all components of the reaction mixture have a low vapor pressure, so that the loss by means of discharge is minimized. Further preferred are oxidations and hydrogenations, in which the components of the reaction mixture have a low vapor pressure.

The devices and processes, which are known from the prior art, by means of which an assembly (=an array) of at least two reaction vessels can be agitated, and can thereby be preferably stirred, are very complex with regard to construction and process, and are thereby in total not cost-effective and time-effective. In particular, this applies to such devices, in which per reaction vessel an agitator is provided, which is to run separately.

In the WO 00/09255 a parallel reactor for the manufacture and testing of combinatorial libraries is described, which provides a plurality of vessels for the uptake for reaction mixtures. Furthermore, the reactor has complex systems for the operating of stir bars, whereby the stir bars are for the stirring of the reactants. The stir bars, which are used for the stirring of the reactants included the appropriate mechanic and the complex control system as well as the sensor technique, which is additionally necessary, are for one part very complex in construction and manufacture and are also enormously costive. Furthermore, the missing flexibility towards changes in the process respectively in changes to other volumes is disadvantageous for such a system.

In an analogous manner, the WO 01/00315 describes an array of reaction vessels, which for the purpose of stirring of the components of the reaction mixture has to be agitated. In this case, the agitation takes place by means of using an orbital shaker, and additionally also by means of individual mechanic agitators in individual reaction vessels. Also the use of ultrasonic for the purpose of the agitation is disclosed in the WO 01/00315.

The EP 1 174 185 describes a system of high-pressure parallel reactors. The stirring of the reaction mixtures takes place by means of a shaker. The EP 1 174 185 also discloses a means for the introduction of a gas into the reaction mixture. However, said introduction of a gas does not serve for the agitation of the reaction mixture, but exclusively for the supply of one reactant before the real reaction. This can already be recognized by the gas being present from top in a reaction vessel, which is explicitly sealed towards the bottom, that means the gas is introduced, but not passed through during the reaction.

The U.S. Pat. No. 5,762,881 discloses a device for the multiple and simultaneous synthesis of compounds. Said device consists of a plurality of test tubes in a defined form, which are clamped in a reaction block. By means of appropriate orifices for supply and discharge, tubes and valves each reaction vessel can be charged individually with reactants respectively reactants can be taken. While the U.S. Pat. No. 5,762,881 specifically and in detail discloses how such a reaction block and the reaction vessels should be formed geometrically, no teaching is given with regard to the agitation of the total reaction block or the individual reaction vessels.

The EP 0 845 029 relates to a device for the serial cultivation of microorganisms respectively cells in liquid columns, which are aerated. Thereby, the device consists of culture bottles, which are fitted with a gas-permeable porous filter plate upside of their bottom orifices, the pore fineness and hydrophobia of which is sufficient stopping the liquid flow from a culture liquid column, which is arranged above said filter plate. Thereby, the EP 0 845 029 is directed very closely to the cultivation of bacteria with respect to its content of disclosure. It cannot be depicted from the EP 0 845 029 how the technique of the aerated liquid column, which is principally known from the state of the art, can be utilized in the field of the high-throughput research for liquid and multi-phase reactions by means of using catalysts.

All the arrays of reaction vessels, which contain a liquid reaction mixture, that is all arrays for liquid phase reactions, which are known from the state of the art, which is relevant here, is common that after the charging of the reactants no supply or discharge of reactants and/or products takes place, that is that the reaction vessels are sealed and the operation of the reaction vessels takes place in the so-called “batch mode”. So, overall, the systems are sealed systems, which are run with predetermined process parameters, as for example pressure and temperature.

The stirring of the reaction partners (components of the reaction mixture) takes place in case of liquid phase reactions in the batch mode according to the state of the art generally by means of elements for stirring respectively in combination with commutated shaking. In these cases the cleaning of the elements for stirring, which is necessary after each reaction, is particularly disadvantageous. Said cleaning work increases with the number of the individual reaction chambers proportionately. It would be alternatively conceivable merely changing all elements for stirring after each reaction. Which step ever is planned, cleaning step or changing step, in each case said step results in an increased time or material complexity and is therefore time intensive and costive.

So, one object of the present invention is to provide devices and processes for the high-throughput research with reaction vessels, which are run simultaneously, which contain a liquid reaction mixture, which are simplified and/or can be used more flexible with regard to the state of the art. Thereby, in particular a good agitation of the components of the reaction mixture should be achieved within very small volumes without the use of mechanic elements for stirring or shaking.

These and further objects are achieved by means of a process for the simultaneous realization of at least one chemical reaction in at least two separate reaction vessels, wherein said process comprises at least the following steps:
(i) providing at least one reaction mixture per reaction vessel;
(ii) pneumatic agitation of the reaction mixture in at least one reaction vessel by means of bringing the reaction mixture into contact with at least one fluid phase,
   wherein the at least one chemical reaction in at least one of the reaction vessels is carried out in the batch mode, and wherein in the reaction mixture at least one liquid phase must exist. There are no restrictions with respect to the type and/or number of further phases.

Thereby, the fluid phase is supplied within a defined period and is at least partially discharged from the reaction vessel within a defined period. In principle, in the process according to the invention the reaction mixture can exist as liquid, as liquid/gaseous as well as as liquid/gaseous/solid phase mixtures.

Furthermore, the present invention relates to a device for the simultaneous realization of at least one chemical reaction in at least two separate reaction vessels, wherein said device comprises at least the following components:
(i) at least two separate reaction vessels with at least one reaction mixture per reaction vessel;
(ii) at least one means for supply of at least one fluid phase in at least one reaction vessel.

Thereby, the means for supply is formed in a manner that it permits the pneumatic agitation of the reaction mixture in at least one reaction vessel by means of the fluid phase. In the device according to the invention, the chemical reaction in at least one reaction vessel is run in the batch mode.

Furthermore, the device according to the invention optionally comprises the following means, which can also be applied in the process according to the invention:

means for the fluid flow control;

means for the phase separation;

means for the fluid metering;

means for the adjustment of parameters;

means for the fluidic sealing;

means for the distribution;

means for the insertion.

It is preferred using as means for the fluid flow control carrier materials and/or deflection plates or other geometrical bodies. As means for the phase separation, that is in particular for the avoiding or the reducing of discharge of reaction mixture from the reaction vessel, it is preferred applying frits, membranes, elements for separation or elements for cooling/condensation. As means for the fluid metering it is preferred using mass flow controllers, valves, multiport valves, gas regulators, etc. Preferred means for the adjustment of parameters in the meaning of the present invention are thermal elements, gas flow meters, pressure measuring devices, etc. Preferred means for the fluidic sealing are screw connections, bracings or pressings; preferred means for the distribution is a gas manifold with restrictors. Finally, preferred means for the insertion are frits, nozzles or membranes. Very principle, one of the means, which is used in the meaning of the present invention, can fulfill several functions at the same time. So, for example, a frit can act as means for the insertion as well as means for the separation of phases (because it prevents the run back of liquid phase into the means for supply).

In principle, in the meaning of the present invention, the agitation of the reaction mixture by means of a combination of flow-through of the liquid phase with at least one fluid (pneumatical agitation) with another means for agitation is possible, for example conventional mechanical stirring or stirring by means of an array of magnetic stirrers or agitation by means of multi-dimensional shaking agitation.

In a preferred embodiment the device according to the invention comprises a bypass. By means of said by-pass a directed circulation of the liquid phase respectively of the reaction mixture is achieved. The directed circulation arises from the density difference of the fluid between supply and outflow of the by-pass, similar to the natural circulation of a natural circulation evaporator.

Finally, the device according to the invention can also provide a data processing equipment for the control/operation of the supply and discharge, or supply or discharge of the at least one fluid. Thereby, such a data processing equipment can fulfill other and/or further functions, in particular the regulation and/or adjustment of parameters.

In the following, the essential terms, which are used in the context of the present invention, should be explained. Thereby, the embodiments, which are each preferred, are mentioned.

Sealing, means for fluidic: A means for fluidic sealing in the meaning of the present invention is any means, which reduces and/or stops the fluid flow between at least two components of the device according to the invention (in comparison to the fluid flow, which would be existent without said means for fluidic sealing). Such a joining, which has to be sealed, exists for example between reaction vessel and means for supply.

There are no principle restrictions with respect to the means for the fluidic sealing to be applied, as long as the requirement mentioned above is fulfilled, and the material, the means is made from, is inert under the desired application conditions and loads in a manner that the function of the device is not affected essentially. For example, such means for the fluidic sealing can be: the pressing of polished or otherwise treated surfaces, in particular of metal surfaces, the use of seals, seal rings, in particular of O-rings, metal rings, graphite, lubricants, Teflon, etc. The connection or the otherwise joining of components, also by using components with elastic force or other methods for the clamping, are also seals in the meaning of the present invention.

Agitation: “Agitation” in the meaning of the present invention is any motion of a macroscopic constituent of the reaction mixture, which is induced from outside, relative to another macroscopic constituent of the reaction mixture. An example for such a relative movement of individual macroscopic constituents of the reaction mixture is the induction of a flow motion, for example by means of mechanic stirring.

However, the present invention does not relate to mechanical agitation, which is induced by means of a mechanical stirrer, but is in fact a pneumatical agitation. Hereunder, in the meaning of the present invention, it has to be understood that a relative motion of a macroscopic constituent of the reaction mixture compared with another macroscopic constituent of the reaction mixture is thus induced that by means of a means for supply a fluid phase is inserted into the reaction mixture or is contacted with said reaction mixture. Thereby, the fluid phase for the pneumatical agitation can be inert, that is does not react with any constituent of the reaction mixture, or, however, can be reactive, that is can react with at least one constituent of the reaction mixture.

Batch mode: A “batch mode” in the meaning of the present invention is an operating method of the reaction vessels, by means of which the reactants are provided within the reaction vessel, then, the reaction vessel is sealed with respect to the reactants (no supply and/or discharge of reactants and/or reaction products possible), and the reaction is started subsequently at it. Consequently, the reactants are not supplied continuously, but at intervals. Also, the reaction products are not discharged continuously. A partial discharge of the reaction products, for example by means of (not desired) discharge together with the fluid for pneumatic stirring or by means of relief of overpressure etc., thereby, has not to be understood as continuous discharge. For example, the term “batch mode” contrary to the term “continuous mode” is known to the one skilled in the art from the chemical engineering inclusively the operating methods of the “semi-batch” and of the “fed-batch”, which are included herein.

Chemical reaction: A chemical reaction in the meaning of the present invention is any reaction, in which at least one constituent of the reaction mixture changes its chemically material properties. For this, in particular, the detachment and/or linking of chemical bonds are among, however, also physical-chemical processes as for example the crystallization, dissolving or precipitation. A chemical reaction does not have to take place at all points of time of the process according to the invention, however, in any case to one point of time.

Insertion, means for: A means for the insertion in the meaning of the present invention is any means, which fulfills the function inserting a fluid phase for the pneumatical agitation, which arises from the means for supply, into the reaction mixture within the reaction vessel. In the simplest case such a means for insertion consists of an orifice of the means for supply, which is turned towards the reaction vessel. In a preferred embodiment, said means for insertion produces an insertion (or bringing into contact) of the fluid phase for the pneumatical agitation with the reaction mixture at positions as much as possible within the reaction mixture.

In a preferred embodiment a medium with at least two orifices are applied, which are different from each other, in particular a medium with a plurality of orifices, which should be formed in a manner providing the formation of bubbles/droplets from a fluid flow. Sieves, grits, or fabrics are preferred. Furthermore, it is preferred applying frits or membranes, which are preferably at the bottom of the reaction vessel.

Frit or membrane have a plurality of pores, by means of which the fluid can enter the reaction mixture, without, conversely, constituents of the reaction mixture can pass the other direction. In order to achieve or to support these properties, it is conceivable hydrophobising or treating otherwise parts of the frit chemically, in order to achieve a desired physical and/or chemical interaction. The diameter of the pores being addressed preferably is from 1 μm to 500 μm, further preferred from 5 μm to 50 μm. The frit or membrane is characterized in that the introduction of the fluid phase quasi can take place in one section, preferably at the bottom of the reaction vessel.

It is also conceivable that the means for insertion has different access points in different levels of the reaction vessel, which, for example, are realized as frit or membrane at the side of the reaction vessel. Such an arrangement can contribute for the optimization and/or homogenization of the agitation.

In another embodiment, the supply of the at least one fluid for the pneumatic agitation takes place by means of an inner tube with nozzle, which dunks into the reaction mixture. In another embodiment, the at least one fluid for pneumatic agitation is inserted into the liquid by means of a nozzle, which preferably is arranged above the liquid level of the reaction mixture, by means of shear rates.

Adjustment of the set of parameters, means for: Means for the adjustment of the set of parameters P in the meaning of the present invention are all means by means of which at least one of the parameters, which can be changed during or before the reaction, is (i) adjusted, (ii) controlled, (iii) operated or (iv) regulated. Arbitrary combinations and/or sequences of adjustment, control, operation and regulation are also included. There is no restriction with regard to the parameters, provided they change or can be changed during or before the reaction.

For example, a means for the adjustment of the parameter set P can be a thermal element, which records the temperature, that is controls the temperature. Such a means can also be a combination of thermal element, computer and heating element, whereby the thermal element records the temperature, the computer compares the temperature with a set value and, if necessary, operates a heating element, the heating power of which can be increased or decreased. Accordingly, also the flow-through of a cooling agent through a radiator coil or the flow rate of the fluid for the pneumatic agitation can be controlled and can be adjusted in dependence on the control factors.

Very principle, the parameters can be adjusted internally (inside of the reaction vessel, for example by means of radiator coils) or externally (from outside of the reaction vessel, for example by means of cooling jacket). In case that the device according to the invention has several sectors, however at least two sectors, with at least two reaction vessels, respectively, it is also possible that for at least two independent sectors also the parameters are adjusted differently (however, within one sector identically). It is also possible adjusting parameters for all reaction vessels individually.

Examples for such parameters are: temperature of the reaction mixture, temperature gradient inside of the reaction vessel, pressure within the reaction vessel, pressure loss along a means for supply or of the reaction vessel, temperature of the fluid for the pneumatic agitation to be supplied, type and concentration of the fluid for the pneumatic agitation to be supplied, distribution of the fluid for pneumatic agitation to be supplied within the reaction mixture, for example in the form of bubbles. In case that said bubbles should be existent as gas bubbles, then, size, size distribution and ascension rate of the bubbles have to be mentioned.

Another important parameter in the context of the present invention is the so-called “holdup”, which is defined as quotient of the volume, which was supplied (here: volume of fluid for pneumatic agitation, which is supplied) related to the total volume (here: volume of the reaction mixture within the reaction vessel plus volume of fluid, which is supplied). Preferably, the holdup is measured with respect of the level of the liquid column. So, for example, the holdup results from the subtraction of the quotient of “level of the reaction mixture in the reaction vessel in the passive state, that is without flow-through with the fluid phase for pneumatic agitation” and “level of the reaction mixture in the reaction vessel during the flow-through of the fluid phase” from one. Thus, the holdup is always lesser than one and is zero in the passive state. It is preferred, that said non-dimensional quotient of the holdup is from 0.05 to 0.8.

The injection rate of the fluid for the pneumatic agitation, which is supplied, preferably ranges from 6 to 30 m/sec, whereas the superficial velocity, that is the velocity which would be existent in case that the fluid for pneumatic agitation, which is supplied, would flow through the reaction vessel without the presence of the reaction mixture, is preferably from 0.05 to 0.5 cm/sec.

A particular important parameter, which can be adjusted, is the temperature. Very principle, hereby all means for heating or cooling can be applied, which are known to the one skilled in the art. It is preferred, using a fluidic heating and/or cooling, whereby the part of the device to be tempered is contacted with the fluid, preferably a liquid, preferably such a liquid as provided in heat exchangers. Preferably, the bringing into contact is carried out in a manner that the heat transfer is promoted or maximized. Preferably the fluid itself, which is applied as heat exchanger, is inter-pumped, stirred, or otherwise moved, in order to promote the outflow respectively supply of heat. It is further preferred that such a means for the adjustment of the temperature also comprises a control mechanism. In a preferred embodiment the fluidic heating/cooling is realized by means of heating coils and/or radiator coils, which are lying outside or inside.

Another means for heating and/or cooling, which is preferred, comprises heating and/or cooling units, which are heated (or cooled) electrically and/or piezo-electrically, preferably made from a material, which conducts the heat well. In the meaning of the present invention, the means for the adjustment of parameters can be applied for all components of the device according to the invention. So, for example, it is preferred, that also the metering and/or connecting lines are tempered.

Fluid: A fluid in the meaning of the present invention is any substance, in which the elementary parts, which build up the substance, for example elements or molecules, but also agglomerates thereof, move towards each other, and, in particular, do not show any distal effects towards each other. For example, such substances are liquids, gases, waxes, dispersions, fats, suspensions, molten masses, powdery solids, and so on. In case that the medium is in liquid form, then such substances can also be multi-phase liquid systems. In any case also all mixtures of the above-mentioned substances are included.

It is preferred that the fluid phase, which is used for the pneumatic agitation in the meaning of the present invention, is an inert or a reactive gas.

In case that the fluid for pneumatic agitation is a gas, then a good stirring and an improved bringing into contact, in particular of the liquid and solid components of the reaction mixture is achieved by means of gas bubbles, which are passed through the reaction mixture. In case that the gas to be supplied is an inert gas, then this is only for the agitation and for the improved bringing into contact, for example of a solid and a liquid phase in the reaction mixture. In case that the gas is a reactive gas, then additionally a reaction has to be considered, which arises from the contact of a solid and/or liquid phase of the reaction mixture with the reactive gas.

For example, in case of initial supply of inert gas an agitation of the reaction mixture can be achieved, which is necessary for the reaction, whereby still no reaction takes place within the individual phases or between the phases. After adjustment of particular reaction parameters or process parameters, as for example pressure and/or temperature, then it can be switched from supply of inert gas to supply of reactive gas. The reactive gas, which now flows through the phase mixture, which is further on for the agitation as well as for the improved bringing into contact of the individual phases, can now react in contact with a liquid and/or a liquid phase with said phase and can so start a reaction.

Further on, the reaction can be influenced by means of the quantity of reactive gas, which is supplied continuously or discontinuously per time unit, as well as by means of the total supply period of the reactive gas. In said case the reaction can be terminated by switching from supply of reactive gas to supply of inert gas. Besides, an appropriate low temperature of the inert gas can be used for the cooling of the phase mixture after the reaction in order to support the function of the cooling elements.

In case that the fluid for pneumatic agitation is a liquid, then no principle restrictions exist with respect to the liquid or the liquid mixture to be applied, except that (i) the liquid or the liquid mixture may only be miscible with the reaction mixture in a degree which is not disadvantageous for the desired process of the chemical reaction. In a preferred embodiment, the liquid or liquid mixture is not miscible with the reaction mixture. Furthermore, (ii) the liquid or liquid mixture has to have a density, which permits the liquid or liquid mixture passing through the reaction mixture preferably in form of droplets or liquid bubbles.

In a preferred embodiment, the liquid or liquid mixture for the pneumatic agitation has a lesser density than the reaction mixture and is inserted into the reaction mixture by means of a means for supply, so that the (lighter) blisters/droplets essentially pass through the reaction vessel from bottom to top along the preferred direction of the buoyancy force and thereby stir the reaction mixture pneumatically. It is also conceivable that a liquid or liquid mixture of higher density than the reaction mixture plunges through said reaction mixture essentially from top to bottom along the preferred direction of the gravitation force and thereby agitates.

By means of controlling of quantity and rate of the fluid phase, which is supplied, regardless whether gas or liquid, in the process according to the invention different stirring or agitation degrees of the reaction mixture can be achieved.

Fluid metering, means for: A means for fluid metering in the meaning of the present invention is any means which contributes and/or which effects that the fluid phase for the pneumatic agitation (what means preferably a gas) can be metered in a controlled and/or reproducible manner to at least one means for supply and/or a means for distribution. Preferably, such means take advantage of a pressure gradient or produce such a pressure gradient or are based on a mechanic and/or hydrostatic effect. Preferably, such means for fluid metering are units, which are known from the handling of gases, as pressure reducers, valves, flow meters, flow controllers (mass flow, volume flow), pumps, blowers, etc.

In case that the device according to the invention has several sectors, however at least two sectors, with at least two reaction vessels, respectively, it is also possible applying for at least two independent sectors also at least two independent means for the fluid metering.

Fluid flow control, means for: A means for the fluid flow control in the meaning of the present invention is any means which changes the course of a directed flow, which is induced by the pneumatic agitation according to the invention, in its direction, whereby this change would not be existent, in case that the means for the fluid flow control would not be present. In a preferred embodiment said means for fluid flow control consist of inert carrier material or structured packages, preferably of ball-shaped geometry or of deflection plates, which are fixed freely or tightly in the reaction vessel, respectively. For the further details reference is made to the figures.

Catalyst: A “catalyst” in the meaning of the present invention is any substance, which accelerates a chemical reaction compared with the course, the reaction would take without the presence of the catalyst. In particular, it is known to the one skilled in the art that the catalyst decreases the activation energy of the reaction, which is in each case of interest.

In the meaning of the present invention, there are no restrictions with regard to the type or to the aggregate state of the catalyst. It is preferred applying heterogeneous or homogeneous catalysts. A heterogeneous catalyst is a catalyst, which exists in an aggregate state, which is different from the aggregate state of the reaction mixture. Preferably, the heterogeneous catalyst is a solid phase (or a part thereof) which is in the (liquid) reaction mixture. In that case the heterogeneous catalyst can also exist as suspension of the solid phase in the liquid reaction mixture. Examples of heterogeneous catalysts are: metals, metal mixtures, in particular finely divided and/or activated metals, in particular comprising transition and/or noble metals, for example Raney nickel as well as metals or metallic components, which are applied on a carrier or are contacted with said carrier, here for example noble metal/carbon combinations or noble metal/oxide combinations.

Accordingly, a homogeneous catalyst is a catalyst, which is miscible with the at least one liquid component of the reaction mixture, that is that said catalyst is in said case a liquid itself.

Phase separation, means for: A means for phase separation in the meaning of the present invention is any means, which contributes reducing or preventing the discharge of the reaction mixture or of parts thereof by means of the effect of the fluid phase for the pneumatic agitation. In particular, it should be avoided that constituents of the reaction mixture are carried along by means of gas bubbles and are discharged by means of a means for supply.

Preferred means for phase separation in the meaning of the present invention are: semipermeable cover or membrane in front of each means for supply, in particular of said means for supply, which are for the effecting of the fluid phase for the pneumatic agitation. In said context “semipermeable” means that in essential the reaction mixture or parts thereof are kept back, whereas the fluid phase for pneumatic agitation is let pass essentially. Further means for phase separation are cooling units, preferably reflux condensers and/or radiator coils, which condense volatile parts of the reaction mixture, which evaporate, and which re-circulate said parts to the reaction mixture by means of dripping.

In a preferred embodiment the fluid for pneumatic agitation is pre-saturated with at least one component, preferably with the component of the reaction mixture, which is the most volatile component, which is thus discharged from the reaction mixture by means of at least partially dissolving into the fluid for pneumatic agitation. Said solubility can thereby be reduced by saturating the fluid with exactly said component partially or completely in a pre-operated step. So, for example, it is possible reducing the discharge of ethanol, which is present as solvent in the reaction mixture, by pre-saturating the fluid for agitation, for example a gas, with ethanol. Such a “pre-saturation” is preferably carried out in a sector of the device, which is termed as “pre-saturator”.

In case that the device according to the invention has several sectors, however, at least two sectors, with at least two reaction vessels, respectively, it is also possible applying for at least two independent sectors at least two independent pre-saturators.

Reaction vessels: A reaction vessel in the meaning of the present invention is any unit for uptake, which can take up the reaction mixture and which can be provided with at least one means for supply. In a preferred concrete embodiment, a cylindrical hollow body is applied, which, in another preferred embodiment, can be tapered and/or can be expanded. In principle, said expansion can be carried out in any form, as long as the cross sectional area of the hollow body at least at one position is larger than at another position. For example, the expansion can be carried out in tapered manner, or along a hyperbola. Also the formation of a bubble (that is cylindrical hollow body—vesicular expansion—again cylindrical hollow body) is included.

Thereby, in particular preferred is the tapered expansion of the hollow body, because herewith the bubble rate, which is induced by means of the insertion of the fluid for pneumatic agitation, is controlled, and, in particular, the formation of foam can be avoided in the upper part of the vessel. Overall, the operating range is enlarged, that is the range for the adjustable flow rate respectively flow quantity of the fluid phase for pneumatic agitation. In particular, the rate is shifted to higher numerical values, at which a “flooding” of the reaction vessel takes place by means of expansion of foam and/or liquid (so-called “flooding rate”). It is preferred in the meaning of the present invention that the upper cross section of the reaction vessels is from 1% to 50% larger than the lower cross section.

In case that a hollow body is applied, then the ratio of height of the hollow body (cylinder) to (average) cross section should be as large as possible, for example larger than 1, preferably larger than 10. For the inner diameter of the cylinder, diameters from 3 to 50 mm are preferred, for the height of the cylinder from 10 to 500 mm, in particular preferred from 150 to 350 mm.

There are no principle restrictions with regard to the materials to be applied for the reaction vessels, as long as said materials do not interact in an unwanted manner with the reaction mixture or effect otherwise the process according to the invention. Exemplified materials are: high-grade steel, in particular V2A-steels, heat-resistant and corrosion-resistant steels, tempered steels; noble metals, alloys, cemented carbide and cemented carbide alloys, in particular Hastalloy®, Inconel as well as titanium alloys; silicon, silicon oxides as well as composite materials, which contain silicon; plastics, in particular heat-resistant and corrosion-resistant plastics as for example Teflon (PTFE), PEEK, etc; glasses, in particular borosilicate glasses, ceramics, in particular oxidic or carbide ceramics, carbon composite materials, etc. Mixtures, blends or composite materials from two or more of the before-mentioned materials are also possible.

There is no principle restriction with regard to the number of the reaction vessels to be applied in the meaning of the present invention, besides that at least two reaction vessels have to be applied. With aspect to practicability, in particular with respect to the supply of the means for supply with the fluid for pneumatic agitation, typically by using of manifolds and/or multiport valves, arrangements are preferred, which comprise 8, 24, 48, 96 or other multiples of reaction vessels.

Reaction mixture: There are no principle restrictions with respect to the reaction mixtures to be used in the present invention, besides that the reaction mixture has to contain at least one liquid phase. The reaction mixture can also contain more than one phase, for example a liquid and a solid phase or two liquid phases, which are not miscible with each other. Thereby, a liquid phase is any phase, which is not solid or gaseous, that is in particular also gases, which are liquefied (for example supercritical carbon dioxide) or liquefied solid bodies (for example molten masses, ionic liquids), flowing masses of high viscosity, non-Newtonian liquids etc.

In a preferred embodiment, the liquid phase is a solvent or a mixture of reactants or both. The liquid phase can also contain a catalyst, respectively can exclusively consist of a catalyst. In a preferred embodiment, the reaction mixture consists of a solvent, in which the reactants are (dissolved and/or suspended and/or emulsified). Further on it is preferred, that additionally a catalyst is in the reaction mixture, either as part of the liquid phase, as a phase of its own (not miscible with the reaction mixture) or as solid phase.

By adjusting the flow rate of the fluid phase for pneumatic agitation a fluidization of said solid phase can be achieved in case of existence of a solid phase within the reaction mixture, for example of a heterogeneous catalyst, that means the solid particles quasi “float” in the reaction mixture. By adjusting the relevant parameters, in particular the flow rate of the fluid phase for pneumatic agitation, different degrees of fluidization can be adjusted. In case that a solid phase is existent within a reaction mixture, which is in essential liquid, then it is preferred that the range of charging with solid, in particular with solid catalyst, is from 0.1% by weight to 50% by weight, further preferred from 1% by weight to 10% by weight.

It is possible applying any further components (additives) to the reaction mixture. At this point, surface active substances (tensides) are mentioned as exemplary components. The feeding thereof in particular results in enlarging the material transport surface, for example by means of producing smaller bubbles/droplets or of more bubbles or droplets.

With respect to the constituents of the reaction mixture or of the products of a chemical reaction, which can occur in practical applications, should be mentioned: heterogeneous catalysts or catalysts, which are made heterogeneous, luminophores, thermoelectric, piezoelectric, semi-conducting, electro-optical, supra-conducting or magnetic substances or mixtures of two or more of these substances, in particular intermetallic compounds, oxides, oxide mixtures, mixed oxides (for example mixtures of two or more oxides), ionic or covalent compounds of metals and/or nonmetals, metal alloys, ceramics, organometallic compounds and composite materials, dielectric materials, thermoelectric materials, magneto-resistive and magneto-optical materials, organic compounds, enzymes and mixtures of enzymes, pharmaceutical agents, substances for feed and feed additives, substances for food and food additives, cosmetics.

Simultaneous: In the meaning of the present invention the chemical reactions are carried out simultaneously, that means at least two reactions take place in at least two reaction vessels at the same time. Thereby, the reactions can be the same or can be different. Furthermore, the reactions can be in an arbitrary stadium that means it is not necessary that two reactions, which take place simultaneously, are in the same condition at the same time. It is solely essential that actually in at least two reaction vessels at at least one time of the process a chemical reaction takes place, respectively.

With regard to simultaneity the type of control of reaction vessels has to be distinguished from the simultaneousness of reaction sequences. In a preferred embodiment the at least two reaction vessels are switched parallelly, that means that each of the at least two reaction vessels has at least one means for supply, which supplies only this one reaction vessel with a fluid for pneumatic agitation (and optionally also discharges said fluid). In a serial control at least one reaction vessel has at least two means for supply, whereby the fluid for pneumatic agitation is discharged by means of a means for supply from said reaction vessel and is supplied to another reaction vessel. In the context of the present invention it is also conceivable that elements of serial and parallel control can coexist.

Flow conditions: If bubbles and/or droplets are formed in the reaction mixture by means of insertion of the fluid phase for pneumatic agitation, which move through the reaction mixture, which preferably ascend in said reaction mixture, then different distributions of the bubbles and/or the bubble size or droplets and/or droplet size (in the following droplets and bubbles are identical) are possible, which can be regarded as different “flow conditions”. With regard to the flow conditions there are no principle restrictions in the present invention, besides that at least a partial agitation of the reaction mixture for at least a defined period has to be achieved.

With regard to the gas bubbles, for example homogeneous (“bubbling”) and heterogeneous (“churn-turbulent”) flow behavior are known to the one skilled in the art. In case of homogeneous flow, in essential one bubble type of a certain size distribution is existent, which flows through the reaction mixture uniformly. On the other hand, in case of heterogeneous flow, at least two different types of bubbles are existent; big bubbles have a higher ascension rate and effect a good stirring (agitation), whereas the smaller bubbles distribute within the liquid phase and have the re-mixing characteristic of the liquid. Thus, plough flow can exist in addition to re-mixing. Thereby, in the meaning of the present invention, any mixing conditions can exist. In particular, it is possible, that at the edge of the reaction vessel a flow profile is formed which is different from the flow profile in the center, as well as that the fluid for pneumatic agitation circulates or partially forms with the liquid phase of the reaction mixture a foamy phase, etc.

Distribution, means for: A means for distribution in the meaning of the present invention is any means by means of which the fluid phase for pneumatic agitation, which preferably is transferred from the means for metering, is distributed to at least two means for supply, which are different from each other, whereby the at least two different means for supply, which are different from each other, belong to at least two different reaction vessels. Preferably, such a means for distribution consists of a manifold with restrictions, that means a “rack-type” segmentation of a duct into several ducts, whereby the inner diameter of the ducts (“restriction”) is selected in a way that preferably an equal distribution of the pressure respectively the flow-through in all segmented ducts exist. In order to achieve an equal distribution it is preferred that the restrictors are preferably equal.

In said context it is also essential that a means for distribution can also act as means for combination in inverted operating method, for example if several offgas streams from several reaction vessels should be combined to one offgas stream. What is said above applies with respect to the use of a manifold with or without restrictions or of a “rack-type” combination of several ducts.

Supply, means for: The at least one means for supply, which is constituent part of the device according to the invention, should serve for the purpose supplying in principle any substance to a reaction vessel, preferably at least one fluid, which is for the pneumatic agitation.

At the same time, a means for supply can be a means for discharge. In the meaning of the present invention any means for supply (feed, inlet) can exist, whereby an arbitrary subset thereof can serve for the outflow (discharge, outlet). The direction of the supply respectively the discharge can be inverted arbitrarily often and at any times in the same means for supply. It is preferred in the meaning of the present invention that a means for supply exists, which is for the supply of the at least one fluid for the pneumatic agitation, as well as another means for supply which is for the at least partial discharge of said fluid. However, it is also conceivable that supply and discharge of the fluid for pneumatic agitation takes place by means of one and the same means for supply.

It is further preferred that the means for supply consist of ducts with polyhedral or circular cross sectional area, whereby the cross sectional area can change along the length of a duct, for example can be tapered, or can remain the same. With regard to the embodiment of such ducts, reference is made to the application DE-A 101 17 275, the relevant content of disclosure of which is fully incorporated here. It is possible that the means for supply are combined, for example from duct and membrane or duct and sealable cover or duct with restriction.

The means for supply can also act as (passive) pressure control elements, in particular as pressure reducer or in case of presence of a plurality of feed lines, which are linked together, to a plurality of reaction vessels also as pressure (equi) distributor. In said meaning the ducts can also be formed in their length, their characteristics and/or their diameter in a manner that the respectively desired pressure adjustment is achieved or optimized.

Preferably, a means for supply of the at least one fluid for pneumatic agitation is at the bottom of the reaction vessel, however, can in specific embodiments be also in addition or alone at the head of the reaction vessel.

Furthermore, the supply of the at least one fluid for the pneumatic agitation can take place continuously or discontinuously. Thereby, the quantity of fluid to be supplied and/or to be discharged is controlled preferably by means of appropriate valve switching mechanisms, which preferably are controlled/operated by at least one data processing equipment.

In the following, exemplary embodiments of the present invention are exemplified at hand of the attached figures. Thereby show:

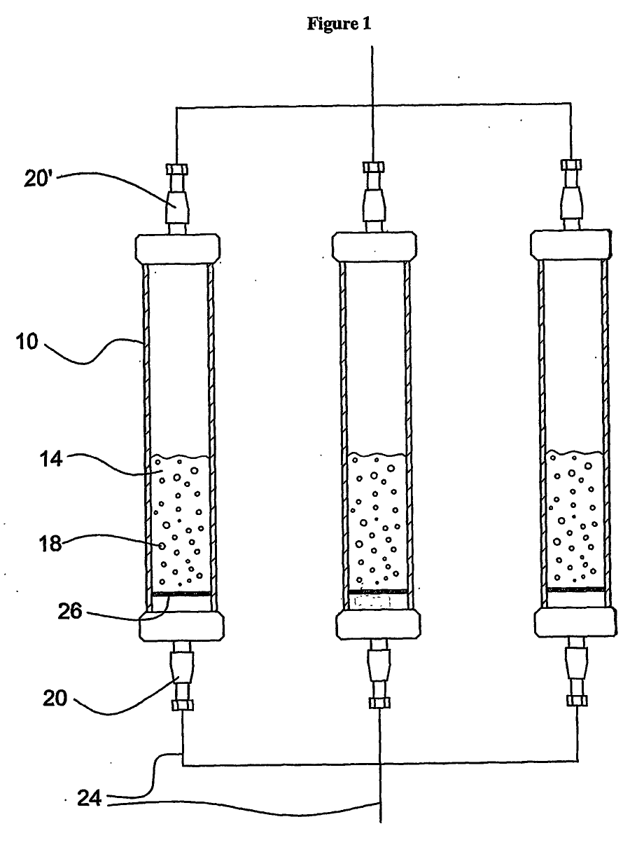

FIG. 1: Parallel arrangement of three reaction vessels, which are flowed through with a fluid for pneumatic agitation, which each contains a reaction mixture.

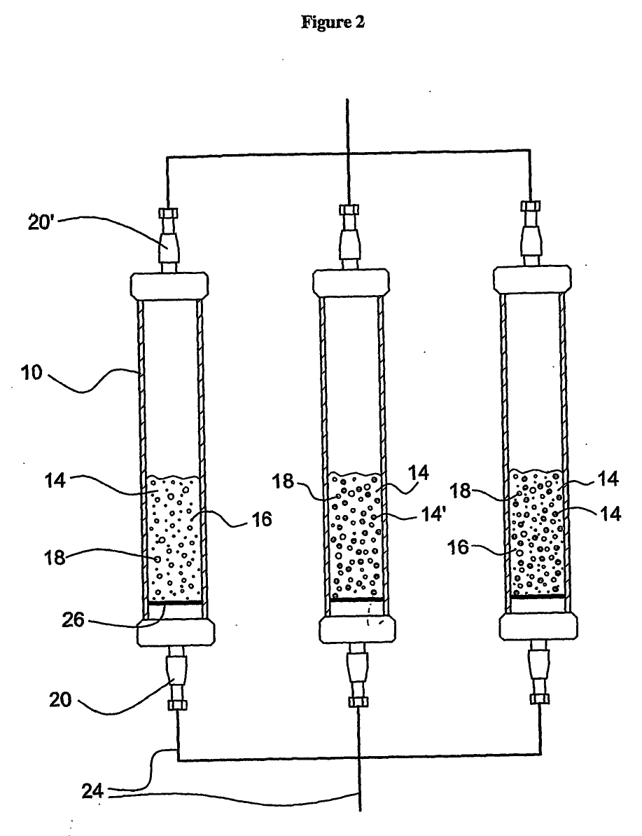

FIG. 2: Parallel arrangement of three reaction vessels, which are flowed through with a fluid for pneumatic agitation, which each contains a different reaction mixture.

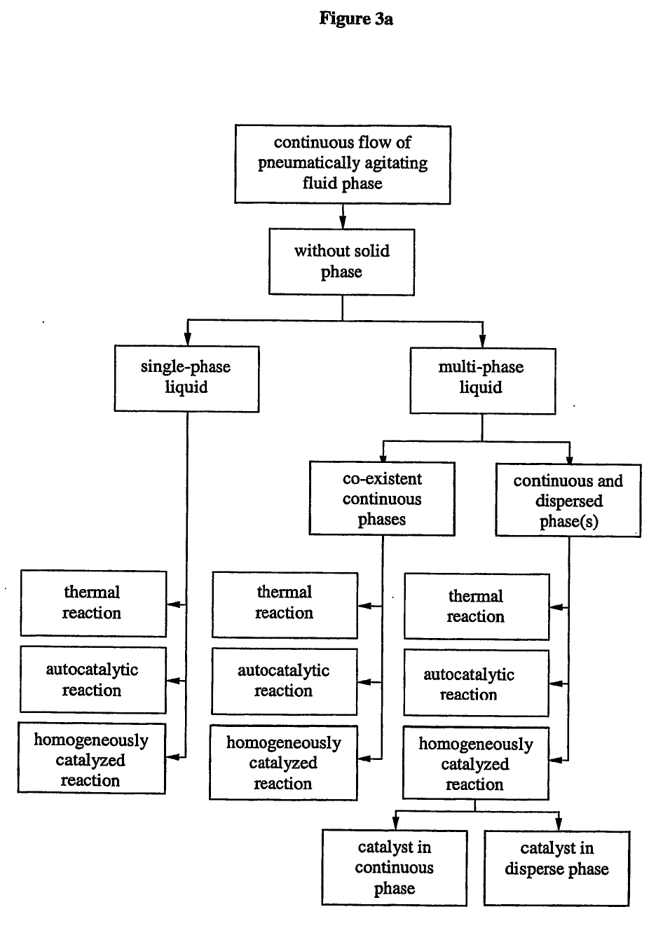

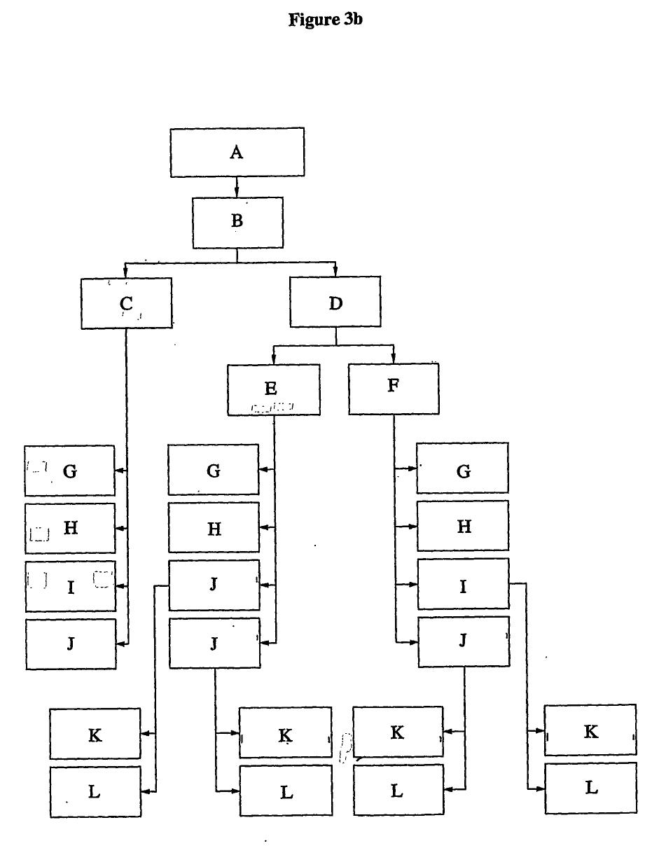

FIG. 3 a, b: Schematic flow chart of the conceivable reactions according to the composition of the reaction mixture.

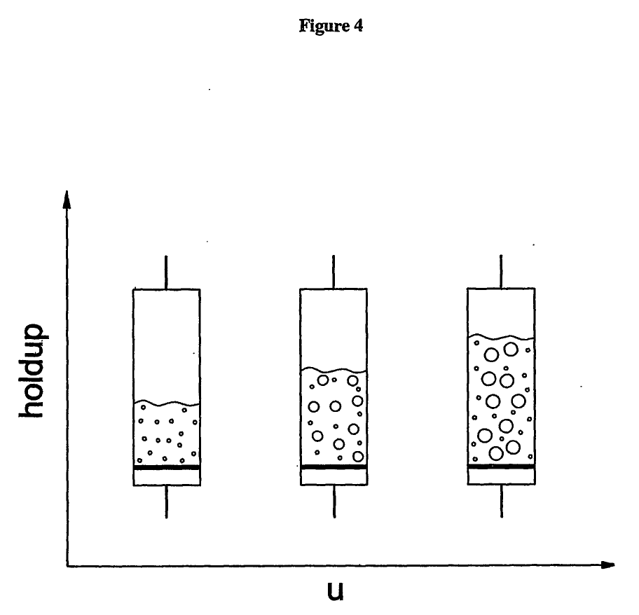

FIG. 4: Schematic illustration of the holdup, (vertical axis) as function of the superficial velocity (horizontal axis).

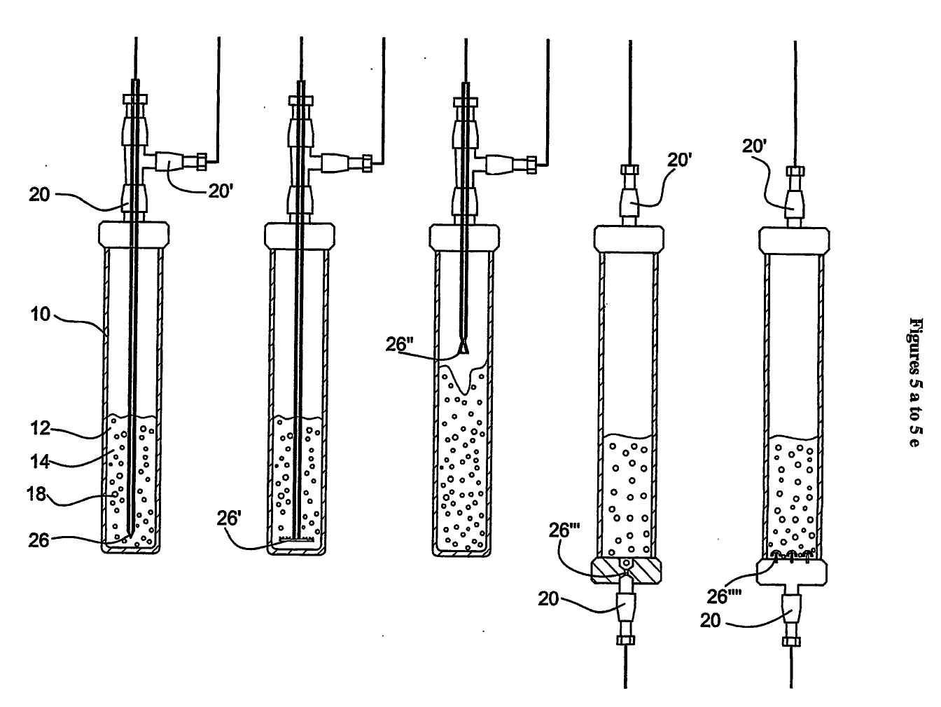

FIG. 5: Schematic illustration of different means for the insertion of the fluid for pneumatic agitation into the reaction mixture.

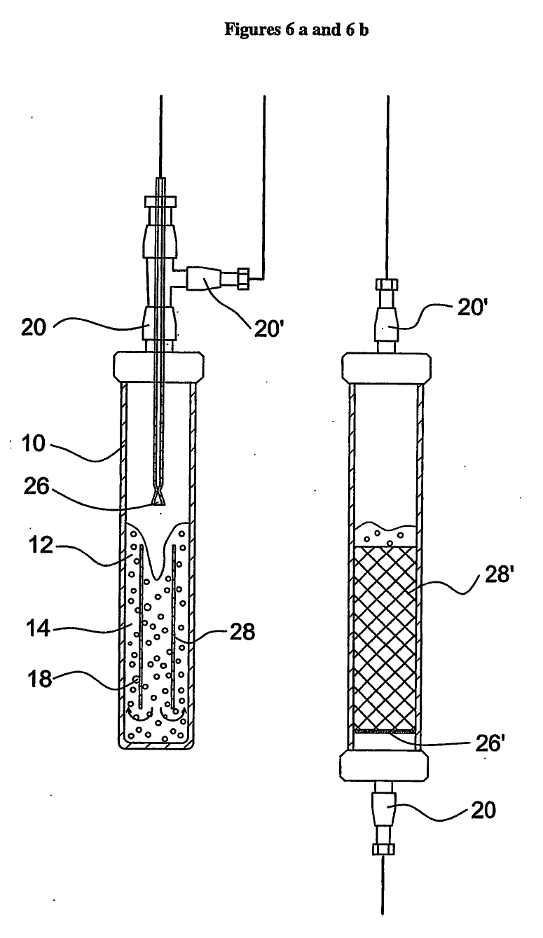

FIG. 6: Schematic illustration of different means for the control of the fluid flow for pneumatic agitation (fluid flow control) within the reaction mixture.

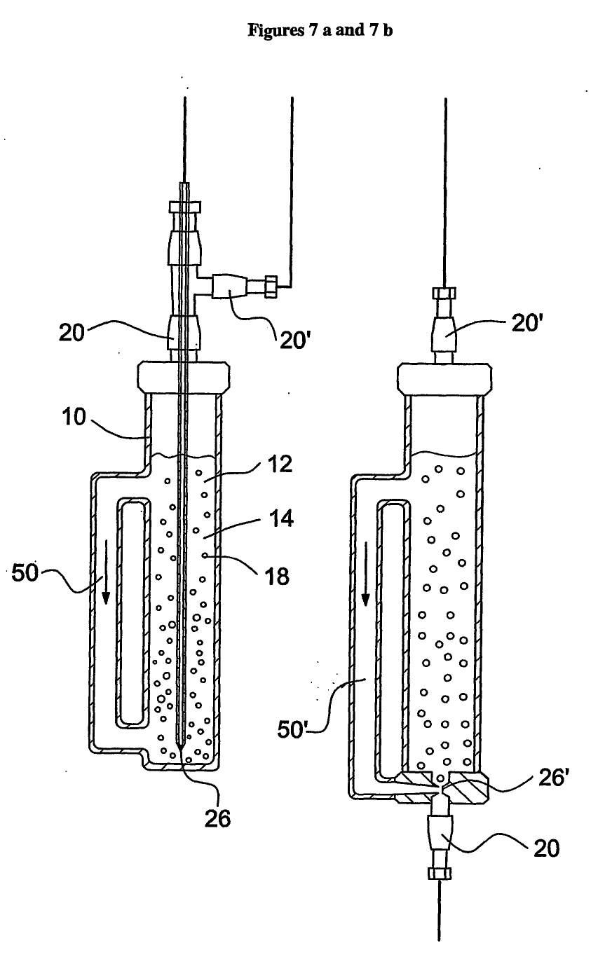

FIG. 7: Schematic illustration of reaction vessels of the device according to the invention with by-pass.

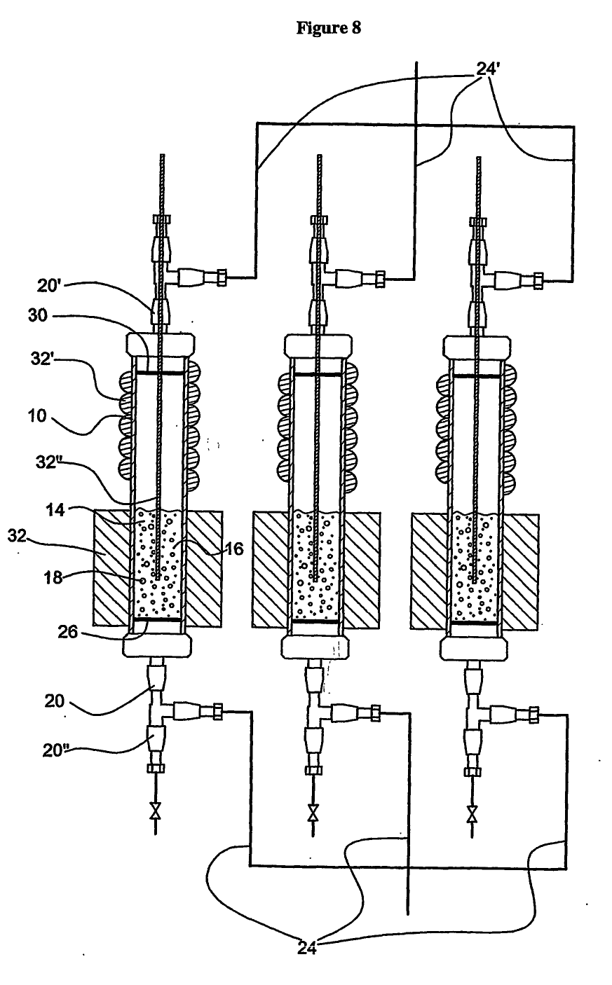

FIG. 8: Parallel arrangement of three reaction vessels, which are flowed through with a fluid for pneumatic agitation, whereby the reaction vessels have different means for the adjustment of parameters.

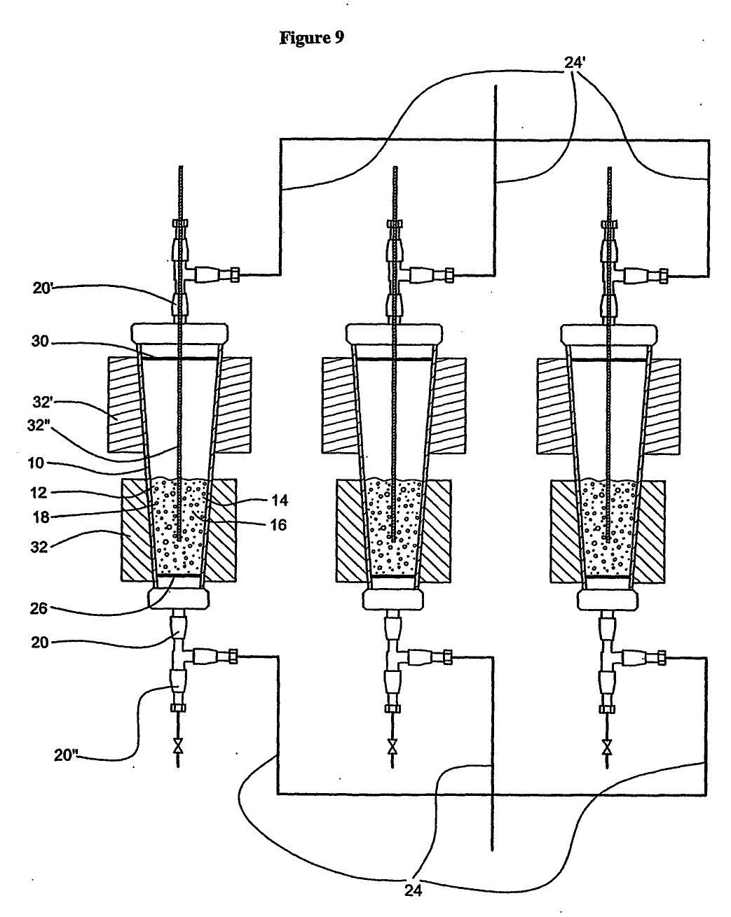

FIG. 9: Is in essential analogous to FIG. 8, with the exception that the reaction vessels diverge taperedly.

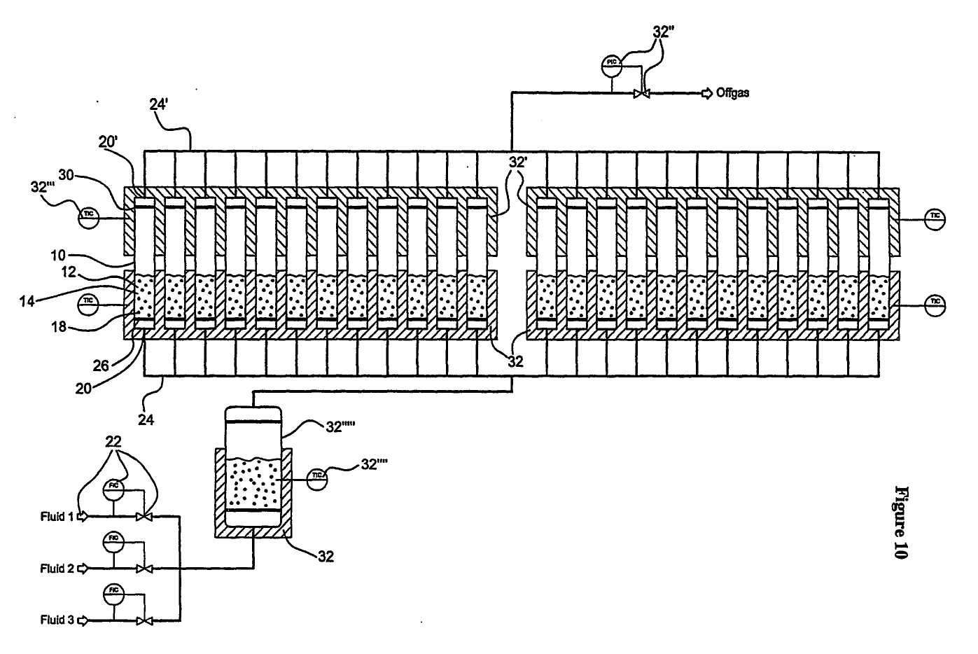

FIG. 10: Parallel arrangement of 24 reaction vessels, which are flowed through with a fluid for pneumatic agitation, which are segmented into two sections with 12 units, respectively; furthermore, a pre-saturator is shown.

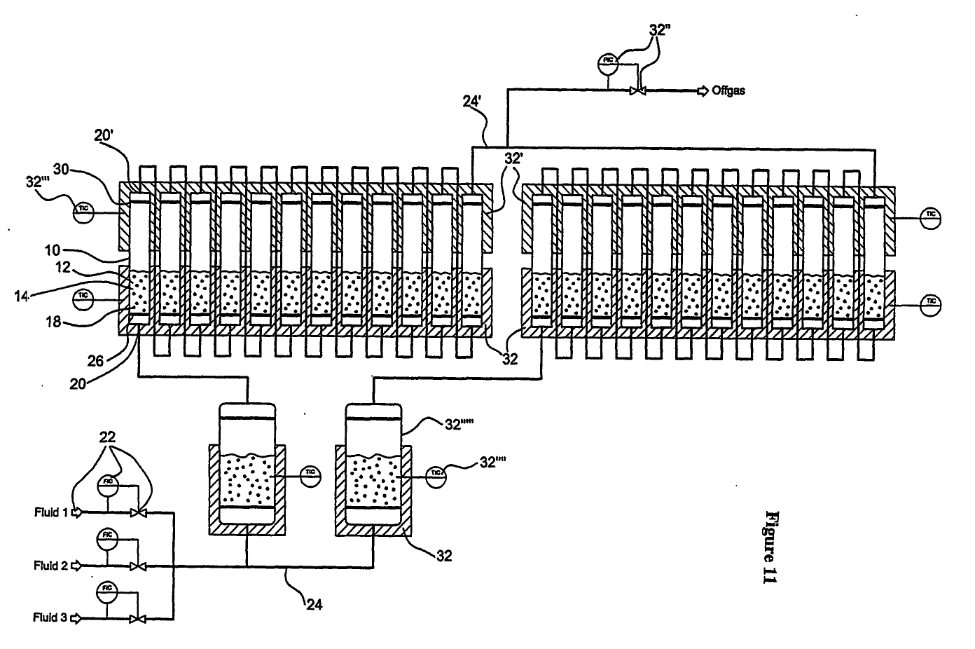

FIG. 11: Serial arrangement of 24 reaction vessels, which are flowed through with a fluid for pneumatic agitation, which are segmented into two sections with 12 units, respectively; thereby, each section is provided independently from the other section, respectively, with a pre-saturator.

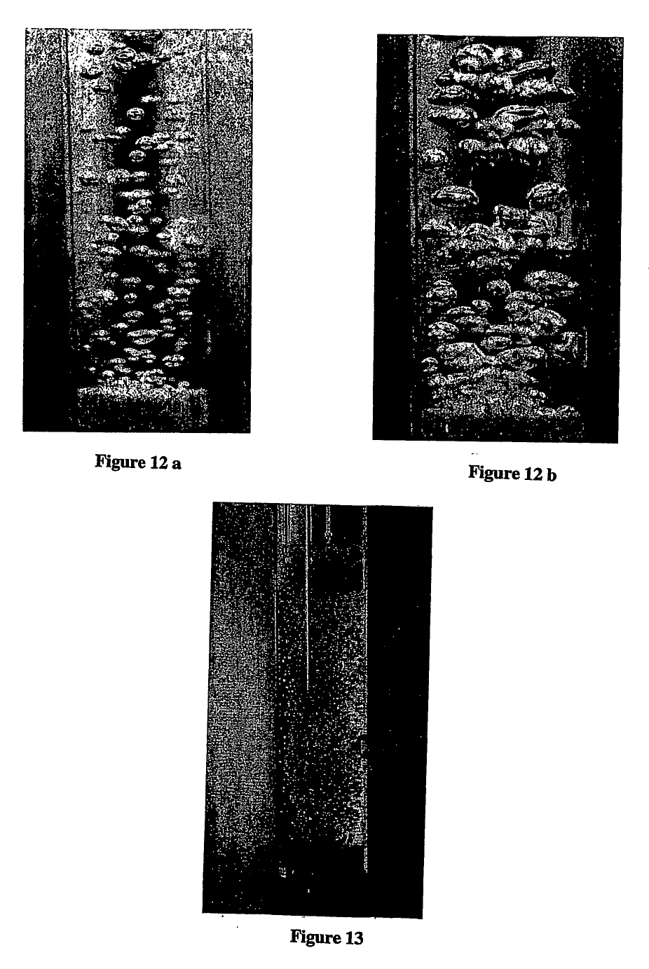

FIG. 12 a, b: Photographic illustration of the dependence of bubble quantity and bubble size on the superficial velocity.

FIG. 13: Photographic illustration of foam forming as well as nearly complete fulfillment with bubbles of the reaction mixture in the device according to the invention.

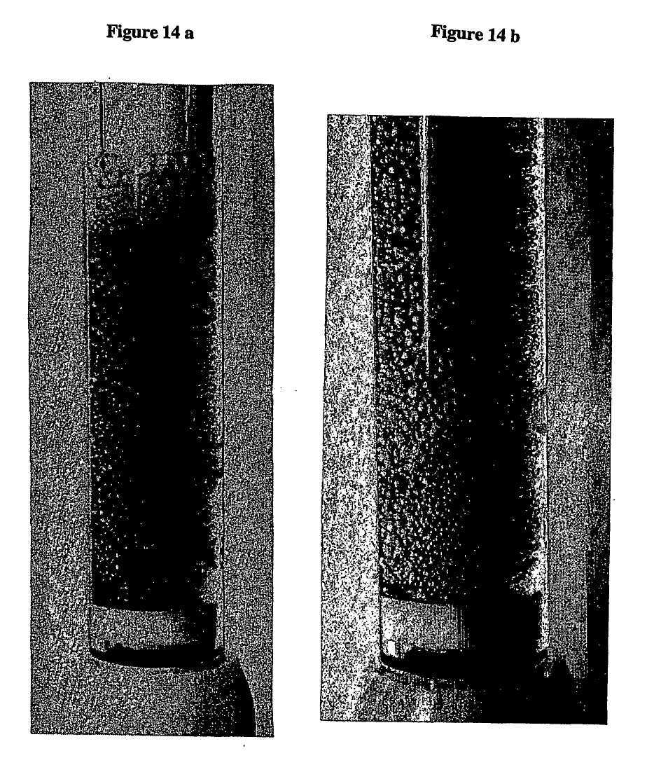

FIG. 14: Photographic illustration of the uniform suspension of a solid catalyst in the reaction mixture by means of application of the process according to the invention.

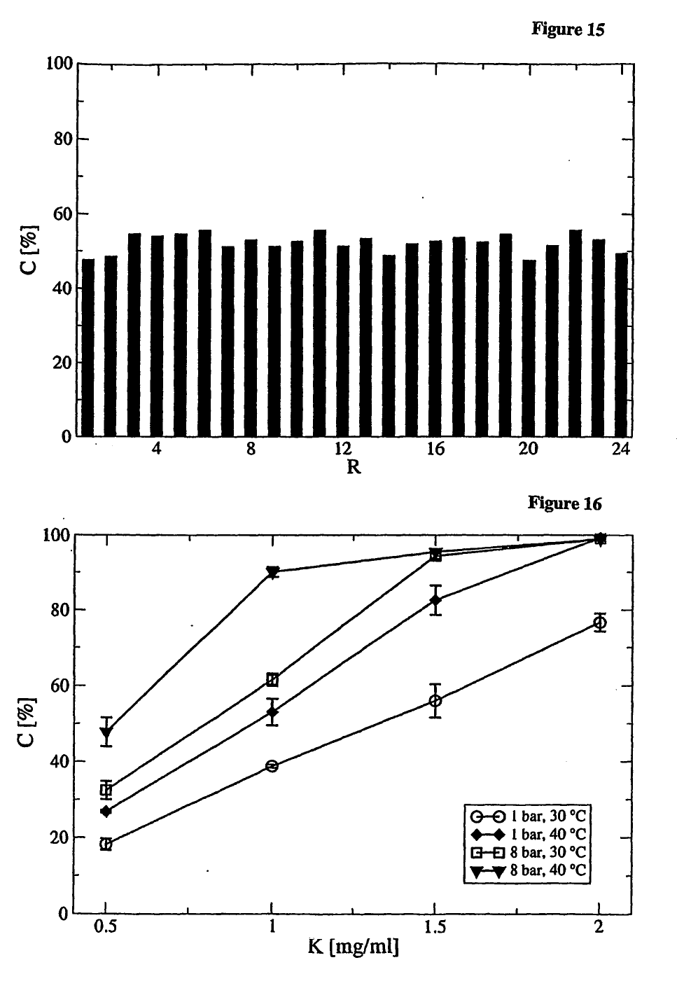

FIG. 15 (to example 1): Conversion degree C. (vertical axis, in %) as function of the reactor number R (horizontal axis).

FIG. 16 (to example 2): Conversion degree C. (vertical axis, in %) as function of the catalyst concentration K (horizontal axis, in mg/ml reaction mixture) for different pressures and temperatures.

The individual figures should be described in the following in detail.

FIG. 1 shows a parallel arrangement of three reaction vessels (10), which are flowed through with a fluid for pneumatic agitation (18), which each contain a reaction mixture, which in this case is a liquid phase (14). The fluid is supplied to the reaction mixture by means of means for distribution (24), connected with a means for supply (20). In this case, the means for distribution consists of a junction of the capillary into three branches. The inner diameter of the capillary in each branch is dimensioned in a way that an approximate pressure equipartition on the three reaction vessels is achieved.

Furthermore, the device according to the invention shows a means for insertion (26), which should effect the distribution of the fluid, preferably of a gas, over a cross sectional area of the reaction vessel being as large as possible. In the concrete case, a PTFE-frit with a defined pore diameter is applied here. Finally, the reaction vessel has another means for supply (20′), which in this case is for the discharge of the fluid phase, which has passed the liquid phase, that means the gas for pneumatic agitation.

This embodiment illustrates one of the advantages of the device according to the invention for the agitation of a reaction mixture: contrary to conventional (mechanical) stirrers, here an agitation is achieved by means of a single “means”, that is to say a single central gas supply. Obviously, this is more effective than the use of three individual stirrers. Furthermore, in the meaning of the invention, the agitation can be varied, stopped or re-restarted at a single position by means of the change of a single parameter, for example of the pressure within the junction.

FIG. 2 shows a parallel arrangement of three reaction vessels (10) which are flowed through with a fluid for pneumatic agitation (18), which each contain a different reaction mixture. In the left reaction vessel, the reaction mixture consists of a liquid phase (14), in which a solid phase (16) is suspended, for example a heterogeneous catalyst. In the central reaction vessel is besides the liquid phase (14) another liquid phase (14′), which is not miscible with the first liquid phase, for example in the meaning of an oil-water mixture. Then, in the right reaction vessel, in the reaction mixture is a solid as well as an additional liquid phase.

The fluid is supplied to the reaction mixture by means of a means for distribution (24), connected with a means for supply (20). In this case, the means for distribution consists of a junction of the capillary into three branches. The diameter of the capillary in each branch is dimensioned in a way, that an approximate pressure equipartition on the three reaction vessels is achieved. However, the capillary has, contrary to FIG. 1, a larger inner diameter, and thus provides a larger flow-through of fluid for pneumatic agitation. For example, this can be reasonable if solid particles should be fluidized. Furthermore, the device according to the invention shows a means for insertion (26), in turn a frit, as well as another means for supply (20′), which serves for the discharge of the fluid phase, which has passed through the liquid phase, that means of the gas for pneumatic agitation.

FIG. 3 shows a schematic flow-chart of the possible reactions, which each can be carried out with a specific type of reaction mixture. In FIG. 3 a, the agitation is carried out without presence of a solid phase in the reaction mixture. Thereby, very principle, the reaction mixture can be single-phase liquid or multi-phase liquid. The reactions, which are possible in the “single-phase liquid” configuration are indicated in the figure. In case of a multi-phase liquid reaction mixture, it has to be distinguished furthermore between coexistent continuous phases and continuous or disperse phases, whereby it has to be distinguished only in the case of the continuous or disperse phase, whether the catalyst is present in the continuous or in the disperse phase.

In FIG. 3 b, the configurations are pointed out, which are possible, if in addition still a solid phase is present in the reaction mixture, in particular a solid catalyst. Naturally, the scheme of junction becomes therefore more complex, because from now on also heterogeneously catalyzed reactions are possible.

FIG. 4 shows a schematic illustration of the holdup, that means the growing of the total volume of the reaction mixture (vertical axis) as function of the superficial velocity (horizontal axis), that means the quantity and distribution of the fluid for the pneumatic agitation, which was inserted into the reaction mixture. In case of comparatively low superficial velocity, which means in the left reaction vessel, only few and small bubbles are formed. Therefore, the holdup, which for example is measured as height of the fluid level, deviates merely from zero, that means from that condition, which would be existent without inserting fluid into the reaction mixture.

By means of increasing the superficial velocity the quantity of bubbles as well as in particular the size thereof can be increased, what leads to an increase of the liquid level and to an appropriate deviation of the holdup from zero (central reaction vessel). A condition, as achieved shortly before the “flooding” of the reaction vessel, is shown in the right reaction vessel: here, the superficial velocity is so high that the reaction mixture nearly fills the whole reaction vessel. The phenomena of the “flooding” and/or the “foam formation”, which both arise from different superficial velocities in dependence on the device, are typically undesired, and have to be avoided or minimized either by means of constructive methods (means for fluid flow control, means for phase separation, etc.) or by means of the controlling of the superficial velocity.

FIG. 5 (a to e from left to right) shows a schematic illustration of different means for insertion (26) of the fluid for pneumatic agitation (18) into the reaction mixture (14). In FIG. 5 a, said means for insertion (26) is a tube, which is fixed at the bottom of the reaction vessel (10). As the tube is inserted into the reaction vessel from top, both the means for supply (20) and the means for supply (20′), which serves for the discharge of the fluid, are at the head of the reaction vessel.

In FIG. 5 b not a simple tube (26) is applied, but in fact a tube with distribution rack (26′), that means an arrangement of at least two outlets. In FIG. 5 c, a nozzle (26″) is shown, which is above the liquid level of the liquid phase (14). In another embodiment, the nozzle also could dip directly into the reaction mixture.

In FIG. 5 d the means for insertion (26′″) consists essentially of an extension in the connection to the means for supply (20), so that all in all a nozzle is existent. Thereby, in the present case, it is a tapered drill hole. Finally, in FIG. 5 e is schematically shown the use of bubble caps (26″″), consisting of chimney and cap. In a preferred embodiment, said bubble caps are self-locking, that means only in case of gas pressure the cap will open. In this meaning the means for insertion act also as means for phase separation, because it is avoided that reaction mixture accesses into the means for supply.

FIG. 6 (a and b from left to right) shows a schematic illustration of different means for control (28) of the fluid flow for pneumatic agitation (18) in the reaction mixture (14). The arrangement as shown in FIG. 6 a, thereby corresponds essentially to the arrangement from FIG. 5 c, with the difference, that two plates (28) are in the reaction mixture, which serve for the control of the fluid flow, that means which turn round the fluid flow, which has been inserted from top, so that also the lateral areas of the reaction vessel (10) are agitated or stirred. In FIG. 6 b a carrier material (28′) or a structured package is shown, which seats on a frit (26). Otherwise, said arrangement corresponds to the configuration, which is shown in FIG. 1.

FIG. 7 (a and b from left to right) is a schematic illustration of reaction vessels (10) of the device according to the invention with by-pass (50). By means of a bypass a directed circulation of the liquid phase or of the phase mixture is achieved. The directed circulation results from the difference in the density of the fluid between supply and outflow of the by-pass, similar to the natural by-pass of a natural circulation evaporator. In FIG. 7 a, the fluid for pneumatic agitation is inserted by means of a tube (26). By means of the difference of lesser dense fluid for pneumatic agitation in the lower and in the upper area of the reaction vessel a circulation in the by-pass is induced, which compensates said difference. In FIG. 7 b, the nozzle (26′) which is at the bottom also sucks the liquid phase from the by-pass (50′), so that thereby a circulation is effected.

FIG. 8 shows a parallel arrangement of three reaction vessels (10) which are flowed through with a fluid for pneumatic agitation (18), whereby the reaction vessels have different means for adjustment of parameters (32). Here, said means are in particular a heating unit (32), which is run electrically, an outer wall radiator coil (32′), which is run in a fluid manner, as well as a thermal element (32″), which extends into the liquid phase (14). Said means for the adjustment of parameters are integrated in an operating and controlling mechanism, which allows a control and an adjustment of the temperature. The means (24), (24′), (20), (20′), and (26) are as described in FIG. 1.

Additionally, here, in the presented embodiment, further means for supply (20″) are provided, in this case connections for fluids, which allow taking samples and/or metering further components to the reaction mixture. Furthermore, the means for phase separation (30) has to be mentioned, which is formed here as a frit, which avoids or reduces the undesired discharge of components of the reaction mixture (with exception of the fluid for pneumatic agitation).

FIG. 9 shows an embodiment, which is essentially analogous to FIG. 8, with the important difference, that the reaction vessels (10) expand in a tapered manner from the bottom to the top side. The expanding of the reaction vessel in a tapered manner determines that the bubble rate, which is induced by means of the insertion of the fluid for pneumatic agitation, is controlled, and in particular foam forming in the upper part of the vessel can be avoided. All in all, the operating range is enlarged.

FIG. 10 shows a parallel arrangement of 24 reaction vessels (10), which are flowed trough with several fluids for pneumatic agitation (18), which are segmented into two sections with 12 units, respectively. The different fluids, for example inert and reactive gases, are provided in a means for fluid metering (22), and the flow properties thereof are adjusted by means of valves and flow controllers (FIC=flow indication control). Subsequently, the fluids access a pre-saturator (32′″″) (see description), in which they are saturated with the volatile component, which could be discharged. The pre-saturator is provided with a means for adjustment of parameters (32) as well as a temperature control (32″″), by means of which preferably a cooling is aimed for, in order to saturate the fluid at temperatures as low as possible.

The pre-saturated fluid, preferably a gas, then distributes in a means for distribution (24) into the two segments with 12 reaction vessels, respectively, as already described several times, by means of a means for supply (20) and a frit, which serves as means for insertion (26). Also the reaction vessels can be cooled or heated by means of means for adjustment of parameters (32, 32′, 32′″). The gases, which flow off, are collected in a means for distribution (24′) and are discharged. Thereby, the means for adjustment of parameters (32″) is for the pressure control (PIC=pressure indication control). Very principle, it is also possible tapping the gas flows individually by means of the use of appropriate multiport valves.

FIG. 11 shows the serial arrangement of 24 reaction vessels, which are flowed through with fluids for pneumatic agitation, which correspond to FIG. 10. Thereby, in turn, the reaction vessels are divided into two sections with 12 units, respectively, and, however, each section is independently supplied from each other one with a pre-saturator (32′″″). Now, an essential difference is that the gas, which flows off from each reaction vessel is the gas, which flows into the next reaction vessel. Thereby, the gas flows from the pre-saturator into the reaction vessels, respectively, on which it is distributed. At the head of the equipment both offgas streams are combined and collected.

FIG. 12 (a and b from left to right) is a photographic illustration of the dependence of bubble quantity and bubble size on the superficial velocity within an arrangement, which corresponds essentially to the scheme, which is shown in FIG. 1. In this figure, the reaction mixture only consists of a liquid phase, that is to say ethanol. In FIG. 12 a it is evident that for comparatively low superficial velocity the bubble size is comparatively low. Accordingly, the bubble size increases with increasing superficial velocity, as shown in FIG. 12 b.

FIG. 13 shows the bubble formation for comparative superficial velocity as shown in FIG. 12 b, however for another reaction mixture, that is to say ethanol in mixture with p-nitrotoluene. In consequence of the change of the material properties, clearly smaller bubbles are formed, however, also clearly more bubbles, what is an advantage for the agitation. At the head of the reaction vessel one can see, how increased superficial velocity can result in foam forming.

FIG. 14 (a and b; from left to right) shows the bubble formation (agitation) for comparative superficial velocities as in FIG. 13, however, for another reaction mixture, that is to say ethanol in mixture with p-nitrotoluene, and therein suspended a solid catalyst (black Pd/C-powder). As can be well seen from FIG. 14 a and enlarged in FIG. 14 b, the catalyst distributes uniformly over the whole reaction vessel.

### EMBODIMENTS

The following examples should illustrate representative items of the present invention without restricting the general content somehow or other by a specific embodiment as described in the description.

### Example 1

### Hydrogenation of p-Nitrotoluene in a Device According to the Invention

For the 24-fold parallel realization of the hydrogenation of p-nitrotoluene to p-aminotoluene in vessels, which are agitated pneumatically, a device according to the invention was used, which corresponds to FIG. 10. In the case at hand, a gas mixture is used as pneumatically agitating fluid, which is provided by means of mass flow controller (as means for fluid metering). Afterwards, the gas flow passes a pre-saturator which is heated to reaction temperature, where it is saturated with solvent (ethanol) in order to avoid a discharge of solvent from the reaction vessels by means of the saturating of the gas in the reaction vessel. Therefore, in the meaning of the present invention, the pre-saturator acts as means for phase separation.

The uniform distribution of the gas flow to the 24 parallel reaction vessels is carried out by means of capillary restrictions, in the present case PTFE-capillaries with an inner diameter of 125 μm (means for distribution).

The 24 parallel reaction vessels consist of borosilicate glass and have an inner diameter of 10 mm and a height of 250 mm. For the insertion of the fluid in a manner as finely distributed as possible, a PTFE-frit a pore diameter of 25 μm (means for insertion) is at the bottom of each reaction vessel. At the head of the reaction vessels a frit was fixed, which were each constructed in the same way, for avoiding discharge of liquid, that means here is another means for phase separation.

At the bottom and at the head of the reaction vessels are standard capillary connectors, by means of which the reaction vessels are connected with the mentioned gas distribution as well as a gas collection at the head. Thereby, the gas collector is a means for distribution, which acts “inversely”. 12 reaction vessels, respectively, are heated in the lower part to the same temperature by dunking into a liquid heat exchanger. At the head of each reaction vessel is a cooling system, in turn available by using a liquid in order to achieve reflux condensation. Thereby, the reflux condensation acts as means for adjustment of parameters, because the temperature is controlled, as well as means for phase separation, because a discharge of the phase to be condensed is reduced or prevented. By means of a pressure controller, another means for adjustment of parameters, a constant reaction pressure can be adjusted for all reaction vessels.

Carrying out the test: An 8% solution of p-nitrotoluene in ethanol is prepared and a Pd/C-catalyst (Degussa, E101 XNN/W 2%) with a concentration of 1.5 mg/ml is added. Besides, the reaction mixture contains a standard (octanol, 2 Ma-%). 3 ml of said reaction mixture are distributed on the 24 reaction vessels, respectively, and said vessels are sealed subsequently. The cooling temperature at the head of the reaction vessels was adjusted to 0° C. At normal pressure and at a superficial velocity of 1 cm/s (holdup: 0.2) the reaction mixtures are firstly flowed through with nitrogen until a constant reaction temperature of 30° C. is obtained.

Subsequently, by switching the gas supply to hydrogen, the hydrogenation is carried out, which is stopped after a reaction period of 20 min by re-switching to nitrogen. By using the mentioned flow-through conditions, the reaction mixtures are stirred uniformly homogeneously and completely. Thereby, the hydrogen acts as pneumatically agitating fluid, which also is provided as reaction gas.

After the termination of the reaction, a sample is taken after the opening of the reaction vessels, respectively, the catalyst is filtrated in parallel and a gas-chromatographical determination of the conversion degree is carried out. From the result, which is presented in FIG. 15, it is made clear that the process according to the invention (by using the device according to the invention) can be carried out with good reproducibility and that the degree of conversion, which can be achieved, is for all 24 reaction vessels uniformly approximately 50%.

### Example 2

### Hydrogenation of p-nitrotoluene in a Device According to the Invention by Means of Parallel Variation of Parameters

In turn, the hydrogenation of p-nitrotoluene to p-aminotoluene was carried out in the device according to the invention, which was already described in Example 1. Thereby, the following test parameters were adjusted: educt concentration 8%, standard concentration 2%, reaction volume 3 ml, superficial velocity 1 cm/s, Pd/C-catalyst (Degussa, E101 XNN/W 2%), cooling 0° C.

In a first test series, which was carried out at 1 bar, the reaction temperature was adjusted to 30° C. for 12 reaction vessels and to 40° C. for the remaining 12 reaction vessels. Additionally, the catalyst concentration was adjusted to values of 0.5 mg/ml, 1 mg/ml, 1.5 mg/ml and 2 mg/ml, so that each 3 reaction vessels with identical reaction mixture were tested under identical conditions. In turn, the reaction was carried out with a reaction time of 20 min. Subsequently, a sample was taken, respectively, and the conversion degree, which was obtained, was determined gaschromatographically.

In a second test series, the first test series was repeated with a pressure of 8 bar, otherwise all test parameters remained the same. The results of the mentioned tests are presented in FIG. 16. From this it is obvious, that the conversion degree C. increases with increasing catalyst concentration K nearly linearly, as expected. Furthermore, an increase of the reaction temperature from 30° C. to 40° C. results in a clearly increased conversion degree. Furthermore, a pressure, which was increased from 1 bar to 8 bar, also results in an increased reaction rate and consequently in an increased conversion degree.

### REFERENCE NUMERALS

10 reaction vessel
12 reaction mixture
14 liquid phase
16 solid phase
18 fluid phase (for pneumatic agitation)
20 means for supply
22 means for fluid metering
24 means for distribution
26 means for insertion
28 means for fluid flow control
30 means for phase separation
32 means for adjustment of parameters
50 by-pass

### REFERENCE NUMERALS FOR FIG. 3b

A continuous flow of pneumatically agitating fluid phase
B with solid phase (packed bed or fluidized bed)
C single-phase liquid and solid
D multi-phase liquid and solid
E co-existent continuous liquid phases
F continuous and dispersed liquid phase(s)
G thermal reaction
H auto-catalytic reaction
I homogeneously catalyzed reaction
J heterogeneously catalyzed reaction
K catalyst in continuous phase
L catalyst in disperse phase

1. Process for the simultaneous realization of at least one chemical reaction in at least two separate reaction vessels (10), wherein said process comprises at least the following steps:
(i) providing at least one reaction mixture (12) per reaction vessel;
(ii) agitation of the reaction mixture in at least two reaction vessels by flowing at least one fluid phase (18) through the reaction mixture,
wherein
(iii) the reaction mixture contains at least one liquid phase (14) and
(iv) at least one chemical reaction in at least one reaction vessel is operated by means of not continuously supplying reactants, but in intervals, and by not discharging reaction products continuously (batch mode), and
(v) at least two reaction vessels are parallelly supplied with the fluid phase for agitation of the reaction mixture.

2. Process as claimed in claim 1, characterized in that the fluid phase for agitation of the reaction mixture is supplied over a defined period and is at least partially discharged from the reaction vessel.

3. Process as claimed in claim 2, characterized in that by means of adjusting the flow rate of supply and discharge, a stationary state is reached with regard to the fluid for agitation of the reaction mixture, which flows through the reaction vessel.

4. Process as claimed in at least one of the preceding claims, characterized in that the reaction mixture contains at least one of the following further constituents:
at least one second liquid phase, which is not miscible with the at least one liquid phase of the reaction mixture;
at least one solid.

5. Process as claimed in claim 4, characterized in that the at least one second liquid phase or the solid or both comprises/comprise at least one catalyst, wherein the catalyst can be homogeneous or heterogeneous and solid or fluid.

6. Process as claimed in claim 5, characterized in that at least two catalysts are provided in at least two reaction vessels, which can be the same or different.

7. Process as claimed in at claim 1, characterized in that the reaction mixtures for each reaction vessel are freely selectable independently from each other.

8. Process as claimed in claim 1, characterized in that the at least one fluid phase for the agitation of the reaction mixture takes part in the reaction or is inert.

9. Process as claimed in claim 1, characterized in that the at least one of the parameters, which can be adjusted in at least one of the reaction vessels, is varied at least temporarily and/or also in sections.

10. Process as claimed in claim 9, characterized in that the at least one parameter is selected from the group comprising: temperature in the reaction vessel, reflux temperature, pressure in the reaction vessel, pressure in at least one means for supply, duration of the reaction, duration of the supply of the at least one fluid phase for agitation; quantity of fluid, which flows through, superficial velocity, concentration of the at least one fluid phase for agitation.

11. Process as claimed in claim 10, characterized in that the control of the parameters in all reaction vessels is carried out in the same manner, or is carried out in at least two reaction vessels in a different manner.

12. Process as claimed in claim 1, characterized in that a homogeneous or a heterogeneous flow condition exists in the reaction vessels.

13. Device for the simultaneous realization of at least one chemical reaction in an array of reaction vessels, wherein said device comprises at least the following components:
(i) at least two separate reaction vessels (10) with at least one reaction mixture (12) per reaction vessel;
(ii) at least one means for parallel supply (20) of at least one fluid phase (18) in at least two reaction vessels,
wherein
(iii) the means for supply has to be formed in a manner that it allows the agitation of the reaction mixture in at least two reaction vessels by means of the fluid phase; and;
(iv) the reaction vessels are sealed during reaction with respect to the reactants.

14. Device as claimed in claim 13, characterized in that the supply of the fluid phase is carried out by means of a plurality of means for supply, which are connected materially with each other.

15. Device as claimed in claim 13 or 14, characterized in that the device comprises at least one further component, wherein said at least one further component is selected from the group comprising:
at least one further means for supplying at least one fluid,
at least one means for fluid flow control,
at least one means for phase separation,
at least one means for fluid metering,
at least one means for insertion of a fluid phase at a position within the reaction mixture,
at least one means for adjustment of parameters,
at least one by-pass.

16. Device as claimed in claim 15, characterized in that (i) the means for phase separation is a membrane or a frit or a reflux condenser or a combination thereof, or that (ii) the means for adjustment of parameters is heating unit, a cooling unit, a pressure controller, a valve, a flow controller, or a combination thereof, or that (iii) the means for fluid flow control is a package of ball-shaped bodies or an arrangement of plates, or that (iv) the means for insertion is a nozzle, a tube or a capillary, an injector, a frit, or a combination thereof, as well as an (v) arbitrary combination of the means (i) to (iv).

17. Device as claimed in claim 13, wherein the reaction vessel is cylindrical and has an inner diameter of from 3 mm to 50 mm and/or a height of from 150 mm to 350 mm.

18. Device as claimed in claim 13, characterized in that the individual reaction vessels are operated in parallel and/or are operated at least partially in series.

19. Device as claimed in claim 13, characterized in that each reaction vessel has at least two means for supplying at least one fluid, wherein the one means serves for the supply of at least one fluid for pneumatic agitation and the at least one other means for supply serves for the at least partial discharge of said fluid.

20. Use of the process as claimed in claim 1 or of the device as claimed in claim 13 for reactions in which at least one liquid phase takes part, in particular for oxidations, hydrogenations, hydrohalogenations, halogenations, hydroformulations, ozonolysis, carboxylations, alkylations, fermentation reactions, polymerisation reactions, manufacture of inorganic solid bodies, waste water treatment, Fischer-Tropsch-synthesis.
